(19) United States
(12) Patent Application Publication
(10) Pub. No.: US 2015/0308710 A1
(43) Pub. Date: Oct. 29, 2015

(54) FLUID HEATER FOR A PUMPING SYSTEM

(71) Applicant: GRACO MINNESOTA INC., Minneapolis, MN (US)

(72) Inventors: Martin P. McCormick, Forest Lake, MN (US); Ryan F. Butler, Brooklyn Park, MN (US)

(21) Appl. No.: 14/442,926

(22) PCT Filed: Nov. 13, 2013
(86) PCT No.: PCT/US2013/069841

§ 371 Date: May 14, 2015

Related U.S. Application Data
(60) Provisional application No. 61/726,371, filed on Nov. 14, 2012.

(51) Int. Cl. F24H 1/14; B05B 1/24

(52) U.S. Cl. CPC F24H 1/142; B05B 1/24

(57) ABSTRACT

A fluid heater system for a pumping system comprises a core, a heating element and a sleeve. The core comprises a body made of thermally conductive material, and a plurality of channels formed on an outer periphery of the body. The heating element is disposed within the core. The sleeve surrounds the core adjacent the plurality of channels. The sleeve is formed of a material having a higher strength than the thermally conductive material of the core. In another embodiment, the plurality of channels is chamfered to form a portion of a common outlet plenum and the core includes a temperature sensor bore located proximate the common outlet plenum.

### BACKGROUND

The present invention relates generally to heaters that are used in industrial applications. More particularly, the invention relates to heaters that are used to provide variable heating to viscous fluids in conjunction with being dispensed by a pumping and spray system.

In spray systems used with highly viscous materials, it is desirable to provide heat to the material within the spray system to facilitate pumping of the material to a spray gun. Specifically, elevated temperatures can reduce the viscosity of the material, making it easier to pump and spray. Highly viscous materials experience a large pressure drop when pumped through conventional heaters that utilize only a single passage through which the material flows. Various heaters have been developed in an attempt to reduce the pressure drop within the heater. Specifically, U.S. Pat. No. 4,465,922 to Kolibas describes a heated core having dual passages through which the material flows. Such a heater utilizes a core and a sleeve that covers the passages that are both fabricated from a thermally conductive material to maximize heat transfer throughout the heater. This heater also uses a temperature sensor that is disposed within an interior of the core proximate a mid-span location of the flow passages. There is a continuing need to improve the performance of heaters used in spraying systems to be able to withstand higher pressures and temperatures, and to be able to more accurately manage temperature of the pumped material.

### SUMMARY

A fluid heater system for a pumping system comprises a core, a heating element and a sleeve. The core comprises a body made of thermally conductive material, and a plurality of channels formed on an outer periphery of the body. The heating element is disposed within the core. The sleeve surrounds the core adjacent the plurality of channels. The sleeve is formed of a material having a higher strength than the thermally conductive material of the core. In another embodiment, the plurality of channels is chamfered to form a portion of a common outlet plenum, and the core includes a temperature sensor bore located proximate the common outlet plenum.

### BRIEF DESCRIPTION OF THE DRAWINGS

FIG. 1 is a schematic of a spray system showing a heater positioned between a fluid pump and a spray gun.

FIG. 2A is a perspective view of the heater of FIG. 1 showing an enclosure connected to a sleeve positioned between an inlet housing and an outlet housing.

FIG. 2B is an exploded view of the heater of FIG. 2A showing a multi-channel core and heat cartridges extended from the sleeve.

FIG. 3 is a partially cut-away exploded view of the enclosure of FIGS. 2A and 2B showing the heat cartridges and a resistance temperature detector (RTD) connected to a circuit board.

FIG. 4 is section 4-4 of FIG. 2A showing the location of the RTD of FIG. 3 relative to an outlet plenum of the core.

### DETAILED DESCRIPTION

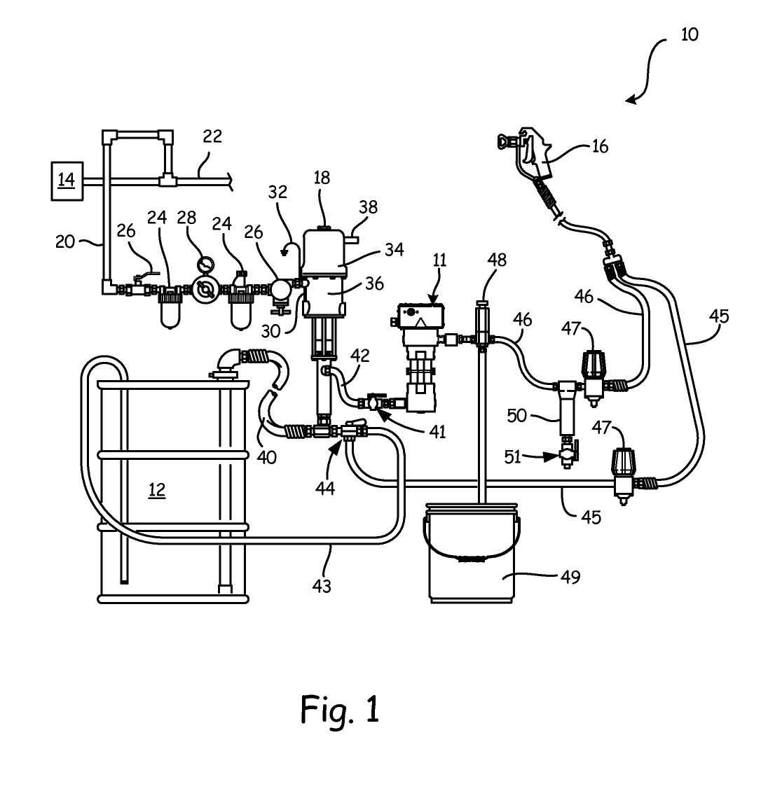

FIG. 1 is a schematic of spray system 10 having heater 11 to which embodiments of the present invention are directed. In addition to heater 11, spray system 10 comprises fluid container 12, air source 14, dispenser 16 and pump 18. Spray system 10 is provided with pressurized air from air source 14 through air distribution line 20. Air distribution line 20 is spliced into air source line 22, which is directly coupled to air source 14. In one embodiment, air source 14 comprises a compressor. Air source line 22 can be coupled to multiple air distribution lines for powering multiple dispensers. Air distribution line 20 includes other components such as filters 24, valves 26 and air regulator 28. Air motor assembly 34 is fed pressurized air from air distribution line 20 at air inlet 30. Pump 18 is connected to ground 32. The pressurized air drives air motor assembly 34 within pump 18, which drives pump assembly 36. After driving air motor assembly 34, the compressed air leaves pump 18 at air exhaust port 38.

In one embodiment, pump 18 comprises a linear displacement piston pump such that air motor assembly 34 drives a piston within pump assembly 36. Operation of the piston within pump assembly 36 draws a fluid, such as paint or an industrial coating, from container 12 through fluid line 40. Fluid line 40 may include a suction tube having a check valve positioned to be submerged within container 12 to maintain priming of pump assembly 36. Pump 18 pressurizes the fluid and pushes it into discharge line 42, which is coupled to heater 11 at shut-off valve 41. Fluid line 43 allows pressurized fluid to drain back to container 12 when director valve 44 is positioned to connect fluid line 43 and fluid line 40.

Heater 11 includes a heating device that heats the pressurized fluid between pump 18 and dispenser 16. Fluid line 45 provides a return from dispenser 16 to pump 18 when director valve 44 is positioned to connect fluid line 45 and fluid line 40. Fluid line 46 connects heater 11 and dispenser 16. Dispenser 16 includes a manually operated valve that, when actuated by an operator, dispenses the fluid. In one embodiment, dispenser 16 comprises a spray gun having an orifice that atomizes the pressurized fluid. Back pressure valves 47 are positioned in fluid lines 45 and 46 to prevent back flow through system 10. System 10 additionally may include pressure relief system 48 that allows pressurized fluid between heater 11 and dispenser 16 to be drained into container 49. System 10 may also include filter 50 with drain valve 51 for screening impurities from the pressurized fluid.

It is desirable to control the viscosity of the pumped fluid in particular spraying operations. Specifically, some fluids become less viscous at higher temperatures, which makes the fluids easier to pump and spray. For example, it is desirable to control the viscosity of fluids that are applied via dispensers employing atomized spraying techniques. Atomized spraying techniques apply a more even, consistent finish when the sprayed fluid has the same viscosity throughout the spraying operation. Heater 11 controls the temperature of the pressurized fluid between pump 18 and dispenser 16 to facilitate a more consistent spraying operation. Heater 11 may be actively controlled with electronics connected to a temperature sensor and heating elements to maintain temperatures of the fluid within a desired band.

In order to pass the pressurized fluid through an in-line heater, it is typically necessary to raise the pressure of the pumped fluid to overcome the pressure losses incurred within the heater. The heater described in the aforementioned U.S. Pat. No. 4,465,922 to Kolibas utilizes dual flow passages within a heater to decrease the pressure losses within the heater. However, the pressures generated by the pump within the heater are still significant and subject the heater to loading that can cause cracking or failure of the heater components, particularly the sleeve, which are fabricated for optimal heat transfer. In one embodiment, heater 11 of the present invention utilizes a heater fabricated of materials having a high heat transfer coefficient between the heating device and the fluid, but having a high strength surrounding the pressurized fluid.

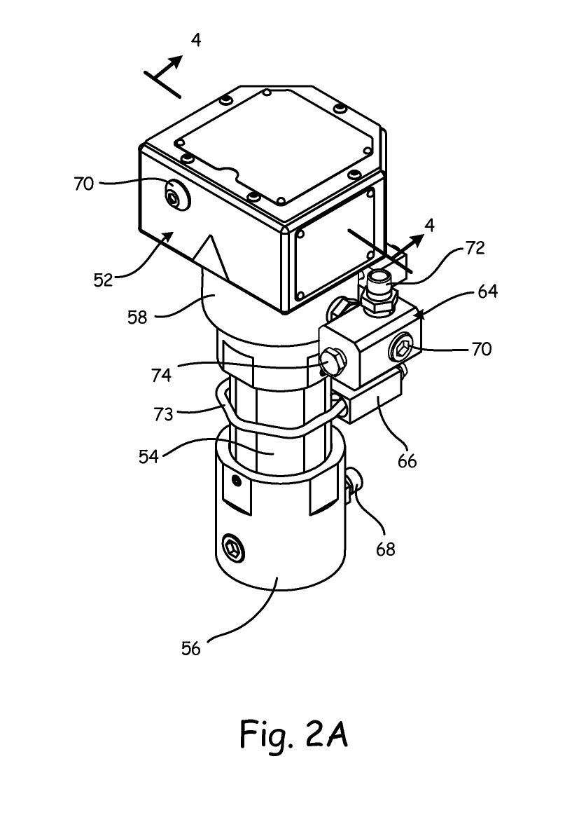

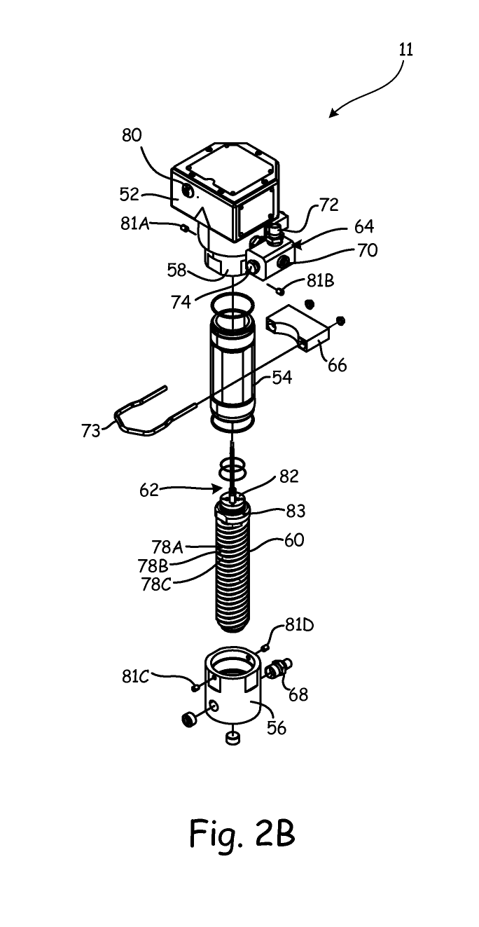

FIG. 2A is a perspective view of heater 11 of FIG. 1 showing enclosure 52 connected to sleeve 54, which is positioned between inlet housing 56 and outlet housing 58. FIG. 2B is an exploded view of heater 11 of FIG. 2A showing multi-channel core 60 and heat cartridges 62 extended from sleeve 54. Heater 11 also includes fluid outlet manifold 64, mounting bracket 66 and fluid inlet 68. FIGS. 2A and 2B are discussed concurrently.

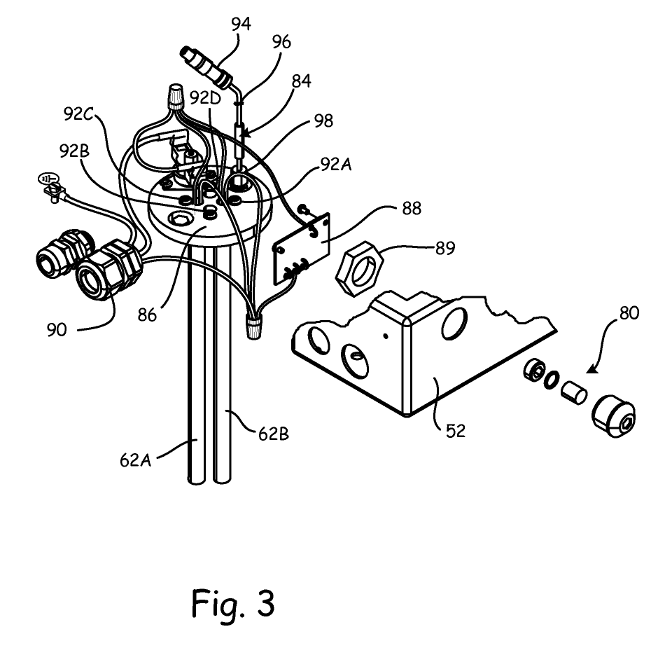

FIGS. 2A and 2B disclose an embodiment of heater 11 incorporating an internal RTD (resistive temperature detector) temperature sensor (See FIG. 3). In such a configuration, outlet manifold 64 includes plug 70, outlet fitting 72 and plug 74. However, in other embodiments, plug 74 can be removed and a thermometer can be inserted into outlet manifold 64. Furthermore, plug 70 and outlet fitting 72 can be switched to accommodate connection with fluid lines in different orientations, such as is shown in FIG. 1.

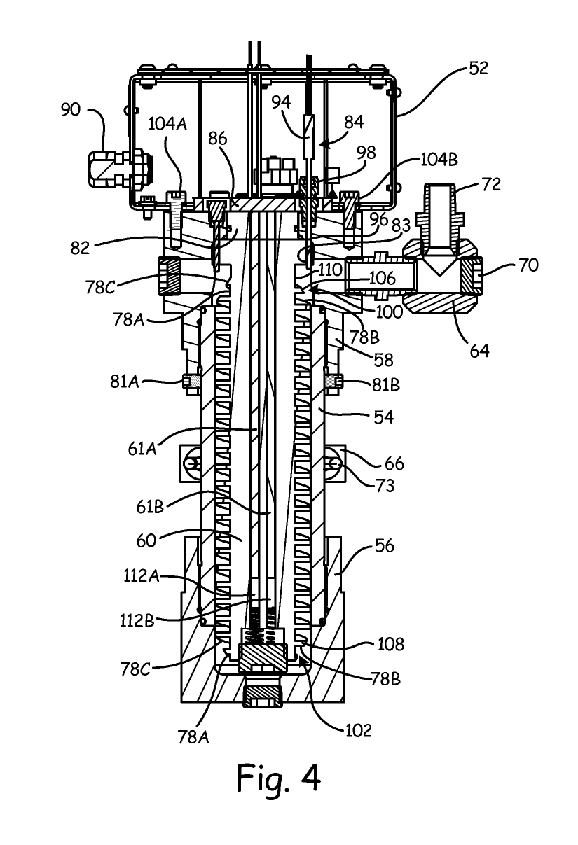

Mounting bracket 66 and U-bolt 73A and nuts 73B are used to secure heater 11 in a desired location, such as near fluid lines for fluid inlet 68 and outlet fitting 72. As discussed with reference to FIG. 1, pressurized fluid enters inlet housing 56 at fluid inlet 68, travels within fluid passages between core 60 and sleeve 54 to outlet housing 58. In one embodiment of the present invention, core 60 includes three parallel flow channels 78A, 78B and 78C, each of which receives fluid at inlet housing 56 and discharges fluid at outlet housing 58. Thermal energy from heat cartridges 62 travels through core 60 to flow channels 78A-78C to lower the viscosity of the pressurized fluid. Simultaneously, the increased total cross-sectional area of flow channels 78A-78C limits the pressure losses generated by heater 11. Flow channels 78A-78C are discussed in further detail with reference to FIG. 4.

In one embodiment of the invention, core 60 is fabricated from a material having a higher heat transfer coefficient than sleeve 54, while sleeve 54 is fabricated from a material having a higher strength than core 60. For example, core 60 may be produced from aluminum or an aluminum alloy, while sleeve 54 is produced from steel, such as stainless steel. Aluminum is approximately fifteen times more thermally conductive than stainless steel, but stainless steel is approximately two times stronger than aluminum. As such, core 60 can be optimized for transferring thermal energy from heat cartridges 62 to flow channels 78A-78C, while sleeve 54 can be optimized for providing strength to heater 11 to withstand the forces generated by the pressurized fluid. Specifically, sleeve 54 plays a small part in transferring heat to flow channels 78A-78C relative to the role of core 60. Additionally, the presence of three flow channels increases the surface area of core 60 that is exposed to pressurized fluid, thereby increasing the heat transfer capability. As such, it becomes acceptable to produce sleeve 54 from a material that has superior strength capabilities to the materials of core 60.

Furthermore, sleeve 54 is readily removable from core 60 so that heater 11 can be disassembled for service and repairs. In particular, sleeve 54 can be removed so that plugged material within channels 78A-78C can be dislodged. Heater 11 can thereafter be reassembled for further usage. In one embodiment, core 60 is force fit into sleeve 54, and sleeve 54 is threaded into inlet housing 56 and outlet housing 58. Additionally, set screws or pins 81A-81D can be used to secure sleeve 54 to outlet housing 58 and inlet housing 56.

With specific reference to FIG. 2B, heat cartridges 62 are inserted into an interior of core 60 through head 82. Heat cartridges 62 are electrically connected to electronics disposed within enclosure 52. For example, heat cartridges 62 and indicator light 80 are connected to a circuit board and mounted to head 82. Indicator light 80 can be used to signal when heat cartridges 62 are active. Furthermore, a thermostat switch and a temperature sensing device, such as an RTD (FIGS. 3 and 4) may be located within enclosure 52. Core 60 includes sensor bore 83 into which a probe for the temperature sensing device extends.

FIG. 3 is a close-up perspective view of RTD 84 and heat cartridges 62A and 62B mounted to cap 86. Enclosure 52 is shown partially broken away and exploded from cap 86. Heat cartridges 62A and 62B, RTD 84 and indicator light 80 are electrically coupled to circuit board 88 within enclosure 52. Indicator light 80 is secured to enclosure 52 using nut 89. Fitting 90 is connected to enclosure 52 to permit power cables to connect to circuit board 88 to provide power to heat cartridges 62A and 62B and other components of heater 11.

Cap 86 is secured to core 60 (FIG. 4) using fasteners 92A-92D. Cap 86 provides a platform for mounting electrical components, such as indicator light 80, and housing components, such as outlet housing 58 (FIG. 4), to core 60. Heat cartridges 62A and 62B comprise elongate heating elements that extend through bores within cap 86 and are inserted into bores within core 60. In the disclosed embodiment, heat cartridges 62A and 62B are electrical resistance heaters. Typically, heat cartridges 62A and 62B suitable for use with core 60 are commercially available from industrial suppliers. Heat cartridges 62A and 62B are electrically connected to circuit board 88 to receive power from wires extending through fitting 90. Heat cartridges 62A and 62B can be removed from cap 86 and core 60 and replaced should heat cartridges 62A and 62B fail or wear out.

RTD 84 extends through a bore within cap 86 and is inserted into a bore within core 60. Although the invention is described with reference to an RTD, other types of temperature sensors, such as thermocouples may be used. RTD 84 includes electrical connector 94 and probe sheath 96, which extends through fitting 98 into core 60. Specifically, as shown in FIG. 4, the tip of RTD 84 extends into sensor bore 83 of core 60 so as to be located in a common outlet plenum for channels 78A-78C.

FIG. 4 is section 4-4 of FIG. 2A showing the location of RTD 84 of FIG. 3 relative to common outlet plenum 100 of core 60. Core 60 additionally includes common inlet plenum 102. Fasteners 92A-92D (FIG. 3) secure cap 86 to head 82 of core 60, and core 60 is inserted through outlet housing 58, through sleeve 54 and into inlet housing 56. Cap 86 is wider than core 60 such that cap 86 engages outlet housing 58 to prevent core 60 from falling to the bottom of inlet housing 56. Set screws 81A and 81B secure outlet housing 58 to sleeve 54. Set screws 81C and 81D (FIG. 2B) secure inlet housing 56 to sleeve 54. Fasteners 104A and 104B secure enclosure 52 to outlet housing 58.

Flow channels 78A-78C extend in a spiral path around an elongate flow section of core 60 from inlet plenum 102 to outlet plenum 104. Sleeve 54 surrounds the elongate flow section to close-off flow channels 78A-78C thereby forming sealed passages between inlet plenum 102 and outlet plenum 104. The ribs formed on core 60 resulting from channels 78A-78C include chamfer 106 and chamfer 108 at outlet plenum 100 and inlet plenum 102, respectively, to ensure that each of channels 78A-78C receives and discharges fluid at a common plenum. Additionally, core 60 is sized-down between outlet plenum 100 and head 82 at neck 110 to prevent formation of blockages in channels 78A-78C between core 60 and outlet manifold 64. As discussed previously, the surface area of flow channels 78A-78C and the thermal conductivity of aluminum core 60 facilitate heat transfer from heat cartridges 62A and 62B to fluid within channels 78A-78C.

Heat cartridges 62A and 62B extend into bores 12A and 12B within core 60. Heat cartridges 62A and 62B are elongate so that a majority of the length of flow channels 78A-78C is heated. Probe sheath 96 of RTD 84 extends through fitting 98, which secures RTD 84 to cap 86. Both heat cartridges 62A and 62B and RTD 84 are connected to circuitry within enclosure 52 that selectively turns on heat cartridges 62A and 62B based on temperature readings taken by RTD 84. The tip of probe sheath 96 extends through sensor bore 83 and into common outlet plenum 100. As such, RTD 84 is positioned to sense a temperature of the fluid within heater 11 that is more relevant to operation of system 10 (FIG. 1).

In prior art systems, such as that of the aforementioned U.S. Pat. No. 4,465,922 to Kolibas, a temperature sensor is positioned centrally within the core near the mid-span of the flow channels. Such a location provides only an average temperature of the material between the inlet and the outlet that is not particularly relevant to a temperature of the material that the heater should respond to. For example, it is desirable to know the actual temperature of the fluid that is being pumped to dispenser 16 (FIG. 1). In particular, during intermittent operation of system 10, it is desirable to know the temperature at outlet plenum 100 when flow starts and flow stops so that heat cartridges 62A and 62B can be operated to more precisely control the temperature of the fluid that is closest to dispenser 16. In embodiments of the present invention, sensor bore 83 allows RTD 84 to sense the temperature of the fluid within outlet plenum 100. RTD 84 is in contact with both the material of core 60 and the actual fluid being pumped so that a more accurate reading of the temperature of the fluid is obtained.

Although the present invention has been described with reference to preferred embodiments, workers skilled in the art will recognize that changes may be made in form and detail without departing from the spirit and scope of the invention.

1. A fluid heater system comprising:
a core comprising:
a body made of thermally conductive material; and
a plurality of channels formed on an outer periphery of the body;
a heating element disposed within the core; and
a sleeve surrounding the core adjacent the plurality of channels;
wherein the sleeve is formed of a material having a higher strength than the thermally conductive material of the core.

2. The fluid heater system of claim 1 wherein the plurality of channels includes three flow-channels extending in parallel along a spiral path.

3. The fluid heater system of claim 1 wherein the sleeve has a thermal conductivity less than a thermal conductivity of the core.

4. The fluid heater system of claim 3 wherein the core comprises an aluminum-based material and the sleeve comprises a stainless steel-based material.

5. The fluid heater system of claim 1 wherein the sleeve is releasably attached to the core.

6. The fluid heater system of claim 5 and further comprising:
an inlet housing connected to the sleeve to at least partially define a common inlet plenum for the plurality of channels; and
an outlet housing connected to the sleeve to at least partially define a common outlet plenum for the plurality of channels.

7. The fluid heater system of claim 6 and further comprising:
a cap connected to the core to prevent the core from passing through the inlet and outlet housings; and
set screws connecting the inlet an outlet housings with the sleeve.

8. The fluid heater system of claim 6 wherein the core further comprises:
a head extending from the body adjacent the common outlet plenum; and
a sensor bore extending through the head proximate the common outlet plenum.

9. The fluid heater system of claim 8 wherein the core further comprises:
a heater bore extending through the head and into the body of the core;
wherein the heating element is disposed in the heater bore.

10. The fluid heater system of claim 8 wherein the core further comprises:
a neck connecting the body of the core to the head adjacent the common outlet plenum.

11. The fluid heater system of claim 8 wherein the core further comprises:
an outlet chamfer disposed between the head and a first end of the body to at least partially form the common outlet plenum; and
an inlet chamfer disposed at a second end of the body to at least partially form the common inlet plenum.

12. The fluid heater system of claim 11 wherein the sensor bore penetrates into the common outlet plenum adjacent the outlet chamfer.

13. The fluid heater system of claim 11 wherein the outlet chamfer and the inlet chamfer comprise cut-backs of the plurality of channels.

14. The fluid heater system of claim 1 and further comprising:
a temperature sensor positioned in the core to sense temperature at the common outlet plenum.

15. The fluid heater system of claim 14 wherein the temperature sensor comprises a resistance temperature detector.

16. The fluid heater system of claim 1 and further comprising:
a fluid pump fluidly connected to the common inlet plenum; and
a fluid sprayer fluidly connected to the common outlet plenum.

17. A fluid heater core comprising:
an elongate flow section extending from an inlet end to an outlet end;
a plurality of parallel, spiral flow channels disposed in the elongate flow section extending between the inlet end and the outlet end;
a first chamfer of the plurality of parallel, spiral flow channels at the inlet end; and
a second chamfer of the plurality of parallel, spiral flow channels at the outlet end;
wherein the fluid heater core is fabricated from an aluminum alloy.

18. The fluid heater core of claim 17 and further comprising:
a neck extending from the outlet end of the elongate flow section;
a head connected to the neck; and
a sensor bore extending through the head toward the second chamfer.

19. The fluid heater core of claim 18 and further comprising:
a sleeve surrounding the elongate flow section;
wherein the sleeve is fabricated from a stainless steel alloy.

20. The fluid heater core of claim 19 and further comprising:
an outlet housing surrounding the second chamfer to at least partially define a common outlet plenum for the plurality of parallel, spiral flow channels.

21. The fluid heater core of claim 20 and further comprising:
a fastener connecting the outlet housing to the sleeve;
a cap connecting the head to the outlet housing; and
a sensor disposed in the sensor bore.
